(19) United States
(12) Patent Application Publication
(10) Pub. No.: US 2020/0055613 A1
(43) Pub. Date: Feb. 20, 2020

(54) SYSTEMS, METHODS, AND DEVICES FOR IMPROVING SAFETY AND FUNCTIONALITY OF CRAFT HAVING ONE OR MORE ROTORS

(71) Applicants: Ralph Irad MILLER, Arlington, VA (US); Wannett Smith Ogden MILLER, Arlington, VA (US)

(72) Inventors: Ralph Irad MILLER, Arlington, VA (US); Wannett Smith Ogden MILLER, Arlington, VA (US)

(21) Appl. No.: 16/545,965

(22) Filed: Aug. 20, 2019

Related U.S. Application Data
(60) Provisional application No. 62/720,098, filed on Aug. 20, 2018.

(51) Int. Cl. B64F 1/12; B64C 27/00; B64C 27/20; B64C 39/02; G05D 1/06

(52) U.S. Cl. CPC B64F 1/125; B64C 27/001; B64C 27/20; B64C 39/022; B64C 2201/148; G05D 1/0676; B64C 2027/005; B64C 2201/027; B64C 2201/066; B64C 39/024

(57) ABSTRACT

An approach is provided for enhancing the safety and functionality of unmanned rotorcraft by improving reliability, transparency, operational capabilities, and effectiveness. Embodiments include integration of rotorcraft with objects attached to the ground (including kites, balloons, or elevated structures) in order to create safe and visible sky moorings from which devices such as cameras on the craft can operate for extended periods of time while remote control can be used to move and stabilize the camera and/or the kite or balloon to which it is attached. In addition, the rotorcraft in such sky moorings can be enclosed for protection, can employ connections for systems maintenance, and can utilize changeable payload modules having supplies that the rotorcraft can dispatch or use in various contexts such as emergency situations or to provide security at venues with large gatherings of people, such as concerts.

### CROSS-REFERENCE TO RELATED APPLICATIONS

This application claims priority to U.S. Provisional Patent Application No. 62/720,098, filed on Aug. 20, 2018, which claims priority to U.S. Provisional Patent Application Nos. 62/491,145, filed on Apr. 27, 2017; 62/512,784, filed on May 31, 2017; 62/540,007, filed on Aug. 1, 2017; and 62/593,008, filed on Nov. 30, 2017, and U.S. patent application Ser. No. 15/963,847 filed on Apr. 26, 2018, the contents of which are hereby incorporated herein in their entirety by this reference.

### BACKGROUND

Recent years have seen an increase in the popularity of unmanned aircraft, which are guided remotely. These unmanned aircraft are sometimes referred to as “drones,” and come in a plurality of forms including rotorcraft that use lift generated by rotating blades, referred to as rotors. Multirotor aircraft are those that have multiple lifting rotors, with names such as quadcopter and hexacopter to refer to aircraft with 4 and 6 lifting blades respectively. Rotorcraft with more than six blades are also known. Present implementations of such unmanned aircraft, while popular and providing recreational value and other utility, pose dangers and have limitations.

Two related limitations on the safety and functionality of unmanned aircraft arise from limited flight durations and low payload capacities. Many rotorcraft use batteries rather than gasoline engines. Electric power has many benefits over the use of internal combustion engines (including lower noise and pollution, simplicity of starting, easier maintenance, and greater reliability), but the capacity and weight of existing batteries limit flight time to the discharge time of the batteries and restrict payload capacity. Short flight times and limited payload capacity, however, interfere with potential uses for the rotorcraft by, for example, public safety officials, naturalists, fishermen, journalists, and photographers. These individuals who observe crowds to watch for suspicious behavior, wait for wildlife or fish to enter a scene, wait for a newsworthy event, or wait for events to reach a time when aerial photography is needed (such as the time a wedding party exits a wedding ceremony) may not be able to use such rotorcraft if the batteries powering the craft last a short time and the craft must be launched from a safe position away from people or ground obstacles. Also, the limited payload capacity for unmanned copters (particularly if affordable and reasonably small) mean that only a few additional capabilities unrelated to flight and control (such as devices discussed below to treat medical emergencies or assist in rescue operations) can be added to any particular copter. Kites, while able to stay aloft in a steady wind for hours with relatively large payloads, can only do so in a relatively limited area, are too unsteady to function effectively as platforms for aerial photography, and cannot be “dispatched” to a different location. Similarly, traditional security cameras or other security devices can be mounted on towers or other elevated structures, but they lack the capability to examine an area of concern closely, to have two-way communications with people in distress or causing disruption, or to deliver medications or activate devices with precision during a crisis.

### SUMMARY

The systems, methods, and devices described herein address one or more of the issues described above by providing embodiments of craft and related equipment that allow safe, accountable, and retrievable operation, and that can be positioned or equipped with specialized features that expand functionality, among other aspects. In addition, embodiments described herein also address concerns which give rise to current and potentially future restrictions by the Federal Aviation Administration (FAA) or other governmental entities on unmanned aircraft.

Safety-related embodiments described herein facilitate long-term storage, ease of deployment, all-weather utility, and simplified retrieval. Functionality-related embodiments described herein support faster launching and retrieval, greater capabilities during adverse weather conditions, more flexible use of cameras, and longer control range, thus further overcoming limitations on flight duration and lifting capabilities.

Certain embodiments describe systems, methods, and devices to enhance the safety and functionality of unmanned rotorcraft by improving reliability, transparency, operational capabilities, and effectiveness. Embodiments include integration of rotorcraft with objects attached to the ground (including kites, balloons, or elevated structures) in order to create safe and visible “sky moorings™” from which cameras on the craft can operate for extended periods of time while remote control can be used to move and stabilize the camera and/or the kite or balloon to which it is attached.

The rotorcraft and sky mooring can either be configured to restrict a moored craft so it remains classified as a structure, “kite,” or “balloon” or can include a launch system that allows release of the craft (either with or without a safety line) to perform specific “assignments” from the operator. In embodiments that include the launch-and-retrieval system, the craft can both leave the sky mooring and also return to the “sky mooring,” where it can again remain moored while charging, changing payload, undergoing other procedures, and operating its camera(s) until another “dispatch” is directed remotely. The ability to position and provision a variety of kinds of rotorcraft easily in “sky moorings” (either temporarily or permanently) coupled with the capability to maintain line-of-sight communication with those craft and with control from a central operations center allows the use of a wide range of special-purpose rotorcraft that can, for example, perform two-way communications with individuals on the ground to evaluate or resolve apparent problems, carry medications or treatment devices to people who may be having a medical crisis, deploy listening or heat-sensing devices to assist with rescue operations or firefighting, photograph or enhance celebrations or ceremonies such as weddings, deploy nets or hooks for fishing when aerial observation or other detection methods suggest fish are present, deliver specialized messages, confetti, or advertising, or be used by law enforcement for traffic incident management or for interventions to reduce risks to the public from disturbances, unidentified packages, or other sources.

A further embodiment is a mooring line system that can be attached to a quadcopter to protect from fly-away or to position the copter for photographs, including selfies. This so-called “control mooring” system can utilize brackets or platforms that are designed for quick attachment and removal to a variety of popular multicopter configurations. A “control mooring” can also be used with a “sky mooring” as described below.

### DRAWINGS

FIG. 1 is a planar view of components of a “landing platform” control system, according to one example embodiment;

FIGS. 2 through 4 are planar views of a kite adapter with a mounted copter, according to one example embodiment;

FIGS. 5 and 6 are planar views of a kite adapter, according to one example embodiment;

FIG. 7 is a perspective view of a kite adapter, according to one example embodiment;

FIG. 8 is a drawing showing a tangle block, according to one example embodiment;

FIG. 9 illustrates a sky mooring enclosure for a copter, according to one example embodiment;

FIG. 10 shows a quadcopter attached to a control mooring in flight, according to one example embodiment;

FIG. 11 shows an exterior view of an embodiment of a sky mooring enclosure with a lid and indent for use of a camera by a moored multicopter, according to one example embodiment;

FIG. 12 shows an interior view of an embodiment of a sky mooring with a slanted shelf structure, according to one example embodiment;

FIG. 13 shows another interior view of an embodiment of a sky mooring with a slanted shelf structure, according to one example embodiment;

FIG. 14 is a diagram of a system capable of configuring an elevated structure and a multicopter for safe retrieval and dispatch, according to one example embodiment;

FIG. 15 is a drawing of a kite and mount with several different quadcopter models that fit on the same mount, according to one example embodiment; and

FIGS. 16 and 17 are planar views of a kite adapter with a mounted copter, according to one example embodiment.

### DETAILED DESCRIPTION

The embodiments described herein are intended for illustration and do not limit the scope or spirit of this disclosure.

In certain embodiments, a horizontal “landing platform” can be created by attaching several fiberglass rods to the bridle in front of a sled or parafoil kite, and the copter can be connected to this “landing platform” in ways that allow the copter to “fly” for a limited distance while remaining physically connected to the kite or, as discussed below, in ways that allow the copter to be released remotely to fly independently. A simple mechanical connection between the “landing platform” and the copter can be achieved, for example, by connecting one or more carbon fiber or fiberglass rods vertically below the middle of the copter (such as by attachment to the landing gear with releasable cable ties) and running the rod(s) through a hole or tube in the middle of the “landing platform” so the copter can move up or down a short distance and can turn or tilt to point the camera. This embodiment can also be used with a copter in a “sky mooring” attached to any elevated structure if the enclosure has a remotely-controlled “lid,” as discussed below.

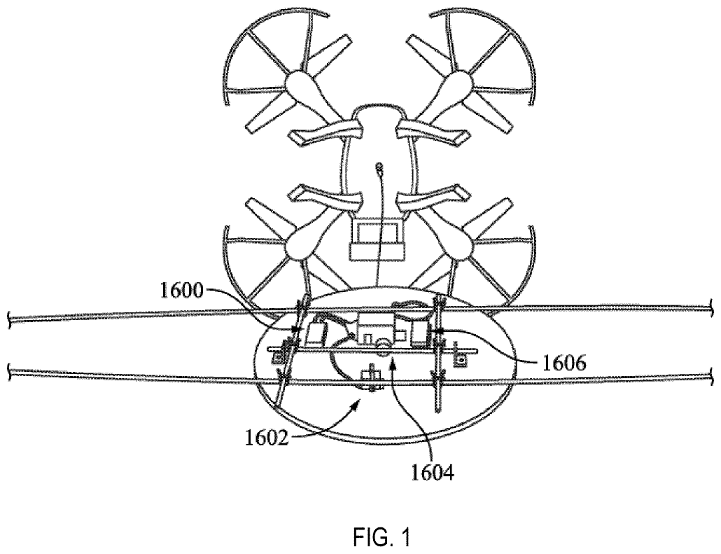

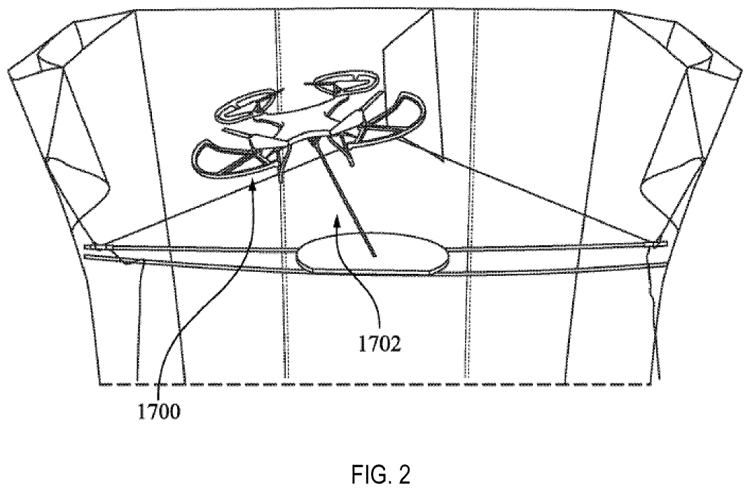

Alternatively, a connection between the “landing platform” and the copter can be made with a line attached to a pulley or drum on a small 360-degree remotely controlled motor (of a type that is readily available for RC aircraft). An example of components of that includes this system is illustrated in FIG. 1, which illustrates components of the RC servo including a battery 1600, a servo to tilt platform up and down 1602, a servo and pulley for mooring line 1604, and an RC receiver 1606. The pulley or drum would be positioned below the “landing platform” with the line going through that platform for attachment to the copter by means of a releasable cable tie (or by passing through an eyelet on the bottom of the copter or on a platform or bracket attached to the copter, as described below in the “control mooring” discussion). The line can then be extended or retracted by rotating the pulley by remote control to allow “flights” of the copter in the immediate vicinity of the kite and then to “reel in” the copter to “land” on the platform again. For example, as shown in FIG. 2, releasing a copter 1700 to hover while connected by a safety line 1702 allows the stability of the camera to be controlled by the copter alone, without vibration or shaking from movements of the kite in the wind. Optionally, power can be supplied through the tether for prolonged operating times. As described below, a variant of this “control mooring” system can also be used with a “sky mooring” (including one attached to a tower or other elevated structure) that uses a “lid” or other top-opening structure.

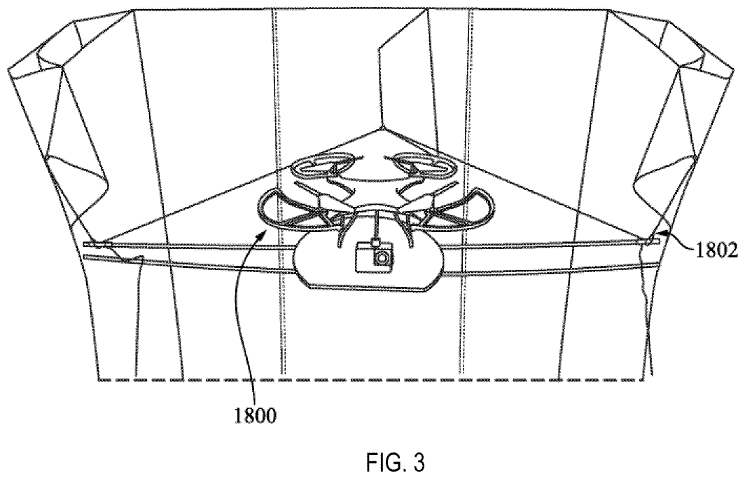

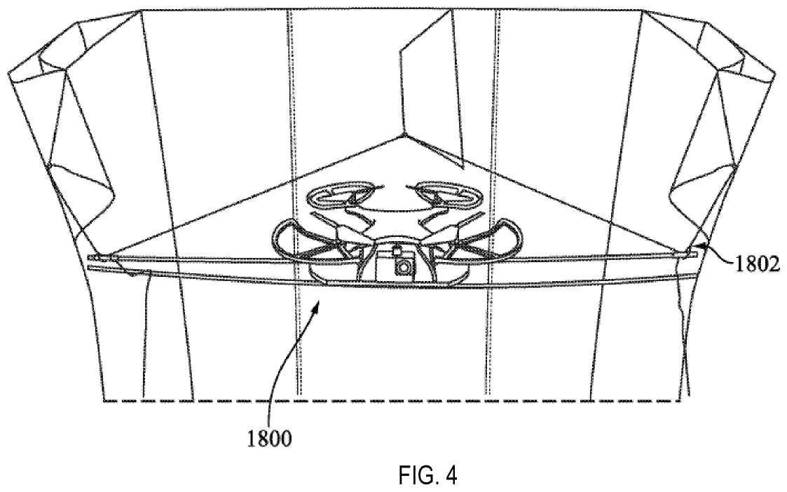

As further illustrated in FIGS. 1, 3, and 4, a platform 1800 can be attached to a bridle 1802 with brackets that allow a “rocking motion” for the platform 1800 that is remotely controlled by a standard RC servo via a second channel in the radio system. With this feature, the copter can be tilted up and down to frame shots in the “landed position” on the platform, as illustrated in FIG. 3 (copter tilted downward) and FIG. 4 (copter tilted upward). The copter can also be rotated in the “landed position” by application of limited lift and by moving the left stick to point the nose of the copter to the left or right. Achieving and holding the “landed position” can be accomplished by retrieving the line until it holds the copter firmly against the platform. The ability to hold the copter in the “landed position” allows the copter's camera to “watch” a scene from an aerial position for extended periods supported by a kite or an elevated structure, with power usage limited to the camera system and RC receiver; for better video shooting, the copter can then be “released” by feeding out line and can hover to frame shots without interference from the kite or bridle while using the copter's gyro systems to stabilize video. One embodiment of this system is to mount a “sky mooring” enclosure so it can be rotated or tilted by remote control to position the camera on the multicopter moored inside; as described in more detail below, this allows video or still photographs to be taken through a window in the enclosure and transmitted to the operator at a remote control center. This mounting would enhance the capability of the camera in the multicopter to function, while moored, as a traffic or surveillance camera.

A further benefit of these mounting embodiments while the copter remains in the “landed position” (or otherwise connect to a kite or “sky mooring” in some way) is that they make it practical to supply supplemental power to the copter (and/or the camera on the copter) through a wire or wires attached to a battery and/or solar panels on the kite or a power source in a “sky mooring” enclosure. In order for a power cord to be used from the kite or “sky mooring” to the copter and/or camera with this mounting, a mechanical restriction on the ability of the rod or rods to rotate is helpful to prevent the power line from wrapping around the vertical rod or rods if the copter is rotated more than 360 degrees while hovering. This can be accomplished by making the rod “D” shaped (or by using two rods side by side) and passing the rod(s) through a small plate or disk on the top of the “landing platform” with a “D” shape or two matching holes for the two-rod system; protrusions can then contact a stop that prevents the plate or disk from rotating more than 360 degrees (and thus prevents the rod(s) and copter from rotating enough to tangle the power cord). Also, in another variation of this embodiment, if the line passes through a loop on the bottom of the copter with one end that is not connected to the pulley or drum and if the loose end is then passed back through the hole in the platform and wound on the pulley with the secured portion of the line, the copter can hover and still be retrieved as long as the free end remains “caught” by remaining line wound on the pulley, but the copter can also be released to fly independently by extending the line fully while adding thrust to lift the copter; the free end of the line then pulls away from the pulley and through the loop (thus releasing the copter), and the pulley or drum would retrieve the mooring line while the copter performs an “assignment” (such as taking pictures of a specific event or delivering rescue equipment) and then lands in another location. If the copter is connected in a way that allows it to apply thrust and fly independently, power sources on the kite can still be connected to the copter or camera while it is close to the kite or the “sky mooring” if the wires have sliding connectors (such as USB plugs or common RC battery charging connectors) that can pull loose when the thrust is applied and line is fed out to release the copter for independent flight.

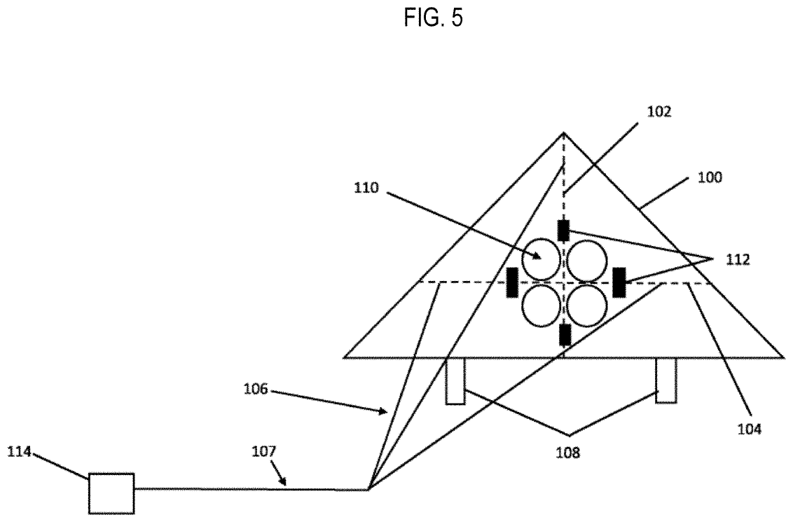

FIG. 5 illustrates a kite adapter 100 for a copter, according to one example embodiment. The kite adapter 100 which, in this particular embodiment, is a delta-shaped kite is configured to be coupled to a copter (not shown for illustrative convenience). Other types of kites can be used for the kite adapter including parafoils, sleds, boxes, winged boxes, diamonds, and arrays of several connected kites. The copter can be any rotorcraft including a quadcopter, hexacopter, or other multirotor craft. The kite adapter 100 includes a spine 102, a cross spar 104, a bridle and cord 106, and a tail 108. The kite adapter 100 also includes four openings 110 to accommodate each of the four rotors of the copter, and brackets 112 to secure the copter in place.

The cord 107 can be a typical kite cord made of rope or a cable that can be tethered or otherwise connected to a controller 114 used by an operator to control the rotors of the copter. After the copter is secured to the kite adapter 100, the kite adapter/copter integrated unit (referred to at times herein as the “integrated unit”) can be operated as a kite, with its orientation and movements being manipulated by controlling the rotors of the copter. As long as the copter is secured to the kite adapter 100, the integrated unit in this embodiment should still fall under the FAA's definition of a kite because the integrated unit illustrated is not designed to fly based on a lift from the copter. In other words, in the absence of wind, the kite adapter/copter integrated unit is not capable of flight. Thus, as with a standard kite, the kite adapter/copter integrated unit must be supported in the air by the force of wind moving over its surfaces. This design feature can be achieved by constructing the kite adapter 100 having a weight that prevents the copter, when coupled to the kite adapter 100, from causing the integrated unit to fly in the absence of air moving over its surfaces from sources such as wind, being towed behind a moving vehicle, or being pulled by a running child holding the string. In such an embodiment, the copter, due to the phenomenon of ground effect, may achieve some minor lift causing the integrated unit to slide across the ground. But this lift is insufficient for flight. Other than the weight of the kite adapter 100, a person of ordinary skill would understand that the copter can also be modified so that it does not provide lift sufficient for sustained flight. For example, the power delivered to the rotors can be reduced such that it cannot provide a lift to the integrated unit. Optionally, the controller 114 could be configured to be in a “kite mode,” where reduced power is applied to the rotors when the copter is installed on the kite adapter 100. Other known modifications to prevent the copter from sustaining the integrated unit in the air can also be implemented.

Though the integrated unit achieves flight by air moving over the kite adapter 100, an operator using the controller 114 can control the copter, which in turn can affect the orientation and movement of the kite adapter 100 in the air. This serves several utilities, including the enjoyment of being able to have a degree of control over the orientation of the integrated unit in the air, such as causing the kite to do “loops” or aiming a camera on the copter for aerial photograph or videos. It also provides a safe introduction or training in copter control for an inexperienced operator with the reduced risk of destruction, loss, or irritation to the public.

Another benefit is that the kite adapter/copter integrated unit can be flown on days when there is too much wind to fly a copter, or other craft, untethered. The integrated unit, with the cord 107 protects against fly-away during training or when wind gusts occur unexpectedly. If the wind is sufficient to maintain a flight of the integrated unit without operation of the copter's rotors, the battery life of the copter is greatly extended, allowing a camera on the copter to be used for a longer period of time than if the battery had to provide both lift and power to the camera. Moreover, since the copter, when used with the kite adapter, is sustained in the air by the wind, as a typical kite would be, the integrated unit would be subject to fewer FAA restrictions than are imposed on unmanned aircraft. If the cord 107 gets cut or the integrated unit otherwise becomes untethered to the controller 114, the integrated unit will descend to the ground as a kite would. Moreover, the rotors of the copter, while not being able to provide a lift to the integrated unit, would assist in a softer landing, thus preserving both the kite adapter 100 and the copter.

Another important benefit is that since the integrated unit is tethered to the operator's location via the cord 107, the integrated unit cannot be used by an operator to invade the privacy of others clandestinely. This is in contrast to a typical “drone” with a camera, where unwanted pictures or video can be taken while the operator is remotely located. As with a typical kite, the integrated unit is tethered via the cord 107.

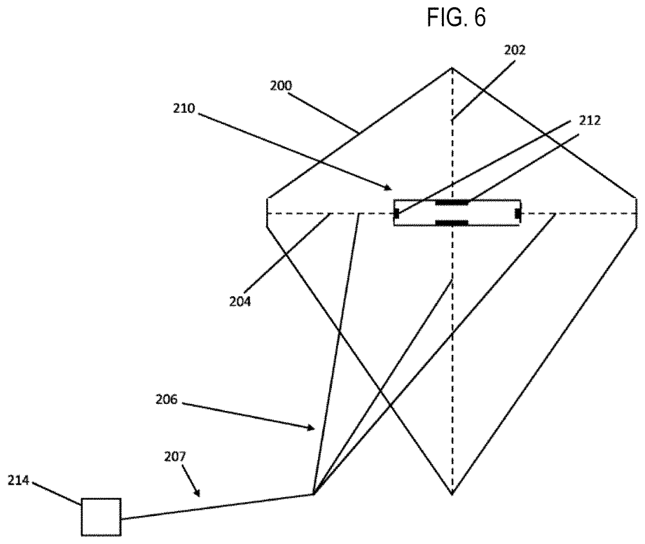

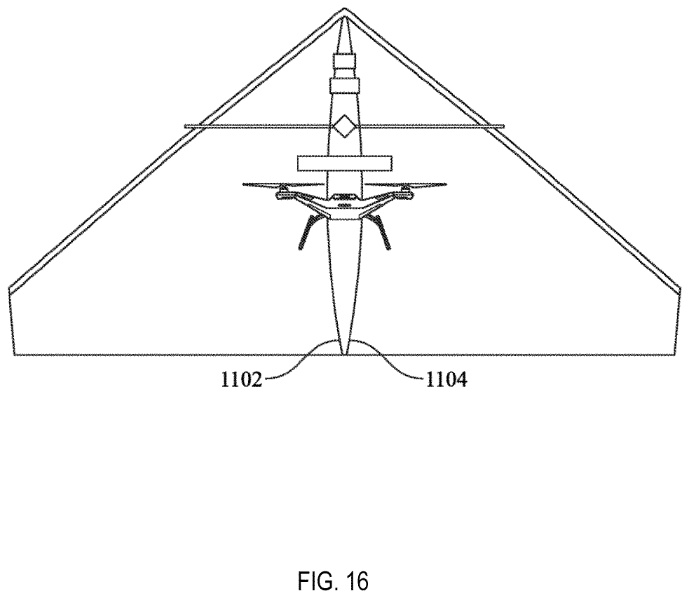

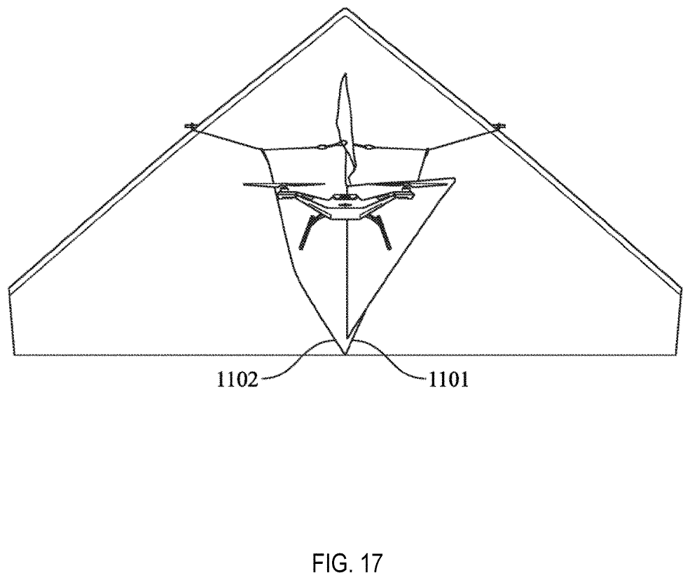

Another embodiment of a kite adapter is shown as reference 200 in FIG. 6. In this embodiment, the kite adapter 200 is configured as a diamond-shaped kite and includes a spine 202, a cross spar 204, a bridle and a cord 206. The kite adapter 200 also includes an opening 210 to accommodate a multirotor aircraft such as a copter (not shown for illustrative convenience), and brackets 212 to secure the copter in place. In this configuration, the copter is mounted such that it is perpendicular to the kite adapter 200. In this way, the copter is in a “gyro position” where the perpendicular relationship between the kite adapter 200 and the copter is like a gyroscope. The “gyro position” can also be used with delta kites, and photography of the area in front of the kite is possible if the standard delta kite bridle is changed. For example, in moderate winds, a SkyDog™ 7′ Sunrise Delta Kite will lift a standard-size toy quadcopter, such as the UDIRC™ U818, mounted in the “gyro position.” This can be achieved by replacing the single vertical rod on the back of the kite with two fiberglass rods 1102, 1104 that are “bowed” to allow the copter to be mounted in the middle between them, as illustrated in FIG. 16. If the camera on the copter is reversed to point toward the rear of the copter (which normally requires only removal of a few screws then turning the camera and replacing the screws), the props can protrude behind the kite while allowing pictures to be taken of the operator and the area in front of the kite during flight, as shown by the copter 1200 with the kite bridle 1202 in FIG. 17; with this mounting, the controls on the copter operate intuitively. Alternatively, the copter can be mounted without modification of the camera position and with the front of the copter protruding on the front side of the kite. Mounting the copter facing the kite operator does not present any issue of control confusion if the copter has a “headless mode” as an ever-increasing number of small copters do. Regardless of the direction the front of the copter faces, the fabric bridle on a delta kite must be removed below the top of the copter to avoid interference with the operation of the copter and camera. In an embodiment, for example, the bottom part of the bridle can be replaced in a way that does not block the lens of the camera, as illustrated in FIG. 17. In this embodiment, a “V” shaped cord is connected from the top left of the cross bar to the bottom middle of the kite (and attached firmly to the bottom of the vertical rod) then run back and attached to the top right of the cross bar. Next, a piece of cord is then attached to run horizontally between the “arms” of this “V,” generally at the level of the bridle's connection point (and through that connection point). The connection point for the line held by the operator must be attached to both the top of the normal bridle and both sides of the line that is connected to the “V” described above. As is known to persons of ordinary skill in the art, when a kite bridle is matched to a particular kite configuration, adjustments to the tension and connection points on this bridle system will be needed for different kite and copter combinations, but the bridle can be optimized and permanently adjusted during the kite-manufacturing process for specific kites when used with a specified weight range of copters. This adjusted bridle configuration restores stability and control that is lost when the bottom of the fabric bridle is removed and also creates an opening on a delta kite below a copter in gyro position, thereby allowing the camera that is normally mounted on the bottom of such copters to take unobstructed photos or video in the direction of the operator; this mounting also allows the copter to influence the orientation and movement of the kite.

In an alternative embodiment, the copter can be mounted such that it functions as a freely moving gimbal and optionally can have a camera attached to it. The copter can then be used to rotate and aim the camera in any direction, regardless of the position of the kite. If fixed to the body of the kite adapter 200, the copter can be used to control the orientation of the kite even though the copter itself (as also described in connection with kite adapter 100) cannot sustain the kite adapter/copter integrated unit in the air. As noted below, this ability to control the camera orientation can also be implemented as an effective control mechanism for a camera in the “sky mooring” embodiment. Variations of this embodiment, as discussed in more detail below, are to mount the copter below or attached to the bridle in front of kites with other configurations (such as sled kites) so a camera on the bottom or bridle of the copter has fewer restrictions in its view or ability to hover or so movement of the copter can pull on the bridle, fabric, or frame to control movement of the integrated unit.

As shown in FIGS. 5 and 6, the cords 107 and 207 are attached to the controller 114 and 214. In an embodiment, the controllers 114 and 214 could include a battery-powered line winder that is designed to attach to the controller. In an embodiment, the controllers 114 and 214 could include a battery-powered line winder that is designed to attach to the controller. Optionally, the line winder could include controls such that an operator could operate the winder with his or her forefingers of each hand when the controller is held in the usual position for moving the levers with thumbs (i.e., an “up” button on the winder that could be pressed with the right forefinger and a “down” button in easy reach of the left forefinger). The winder, rather than battery-powered, could also be a manual crank winder or could draw power from an auxiliary plug on the controller or another power source. In embodiments where the winder is powered, a manual crank could still be provided as a safety option if the power fails. The crank might be designed, when not needed, to be folded and pushed into the hollow middle of the shaft around which the line is wrapped so it is not in the way during powered operation. The line release and line retraction operations of the winder could also be integrated with the throttle control of the controller. A variation of this embodiment could use multiple lines and multiple winders, as discussed below.

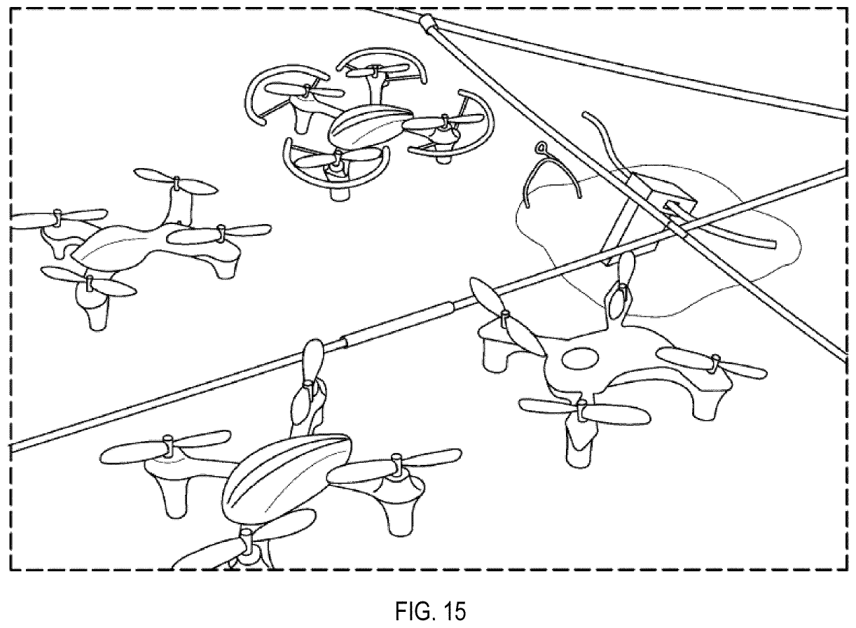

Optionally, the controller 114 or 214 can be configured with a “takeoff’ mode, where all rotors of the copter are activated at full thrust for a period of time while the integrated unit is pulled for launching as an operator would with a typical kite. Activating the rotors would create a supplemental lift at full power to assist the integrated unit in taking flight. The copter could also have a setting that changes the calibration of its gyroscope to adapt to the normal orientation of the kite component or directions for changing the copter's calibration could be included in instructions for an after-market kite adapter. Without this feature (and without performing gyro recalibration to “kite flight position” as described below), some popular multicopters will attempt to maintain stability in level flight, which can make launch of a kite or balloon more difficult, rather than providing full power, and which can reduce the effectiveness of the copter in controlling the integrated unit during flight. In some configurations, an option to disable any “altitude hold” feature in the copter may also improve the maneuverability of the integrated unit. In an embodiment, copter makers could add a “kite mode” button that changes calibration automatically and performs other adjustments for use on kites that make lever operation more intuitive. No copters currently have “kite mode” settings because copters have not been sold for use with kites. Because no copters with a “kite mode setting” exist yet, manual recalibration is needed. Step-by-step recalibration procedures have been described in the instructions for embodiments of “copter kites.” These procedures do not make any physical change to the copters but do allow temporary recalibration by the consumer of multicopters to “kite flight position” after they are mounted for use on a kite. For example, the Holy Stone HS170 shown in FIG. 15 can be easily calibrated if it is attached to the mount and the kite is placed in a position with the bottom about 5 inches back from a wall and with the point leaning against the wall (with the bridle on the same side as the wall). This places the copter in “kite flight position,” which is the same orientation that it has while attached to the kite in flight. After binding the copter to the transmitter, the gyro on the model HS170 can be recalibrated to a “kite flight position” orientation by pressing the thrust lever (also called the “throttle” and located on the left in “Mode 2 transmitters” typically sold in the US) down and then by placing both levers in the lower left corner until the lights on the copter flash. When the lights stop flashing and are constant, the levers can be released; the effectiveness of the calibration operation can then be tested by checking to be sure all four rotors operate at equal power when thrust is applied with the copter in “kite flight position.” (If this process fails to recalibrate, a troubleshooting procedure as explained in the instructions for the HS170 is to repeat the steps except to place both levers in the bottom right corners.) For the three Hubsan X4 copters shown in FIG. 15, gyro calibration in “kite flight position” is accomplished by holding the thrust lever to the lower right corner and moving the other lever back and forth from left to right until the lights on the front of the copter blink. Similar calibration sequences are available for the gyros on all consumer multicopters. To restore gyro calibration for level flight, the copter is placed on a level surface and the calibration steps are repeated.

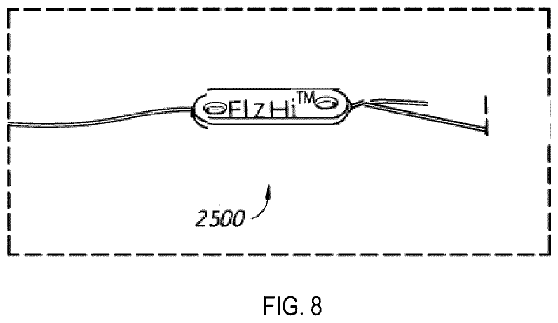

In one embodiment, as shown in FIGS. 5 and 6, one potential issue is that the bridle or cord can get caught in the rotor blades of the copter. To avoid this, the kite adapter described herein can include a mesh material or other netting that is configured to surround the rotors such that neither the kite adapter material, bridle, cord, tail, nor other parts can get caught in the rotor blades. The mesh could be made from fabric or a sturdier material such as plastic. Not only would the mesh isolate the rotor blades, it would also provide additional wind resistance to support the kite adapter/copter integrated unit in the air. The mesh could be a sphere that opens at its diameter and clasps over the rotor. In this embodiment, the sphere could have the appearance and feel of a “wiffle ball.” Other materials and shapes that isolate the rotor blades from the kite adapter can be used and do not depart from the scope of this disclosure. The use of a light-weight, removable enclosure for each rotor (or other barrier such as tubes or coating around the bridle and part of the tether cord) that prevents lines from becoming entangled in the rotors can be an aspect of all embodiments in which a kite, tethered balloon, and/or safety line is used. Use of a 1 to 2 meter length of heavy line (such as 1000 pound test Kevlar™) has also been found to reduce the issue of line tangling in the rotors by providing weight and resistance to tangling that keeps the line near the copter from blowing into the rotors and rarely, if ever, winds around rotors or their shafts. In another embodiment, a lower-cost alternative for production purposes to reduce line tangling is the attachment of a small weight 2500 as shown in FIG. 8 that can be positioned on the line between 12 and 48 inches below the attachment point on the kite. For identification of this component in instruction booklets and marketing materials, the term “tangle block” has been coined. In one embodiment, a “tangle block” 2500 as illustrated in FIG. 25 can be used to reduce line tangle. In another embodiment, the function of the “tangle block” can be performed by attaching a length of approximately 2 meters of heavier line can be attached as a “leader” for the portion just below the snap swivel. Like the “tangle block,” a “leader” of the heavier line provides weight and rigidity that reduces or eliminates the tendency for a lighter line to become tangled in the rotors, either in flight or during launches and landings.

### “Control Mooring” for Rotorcraft

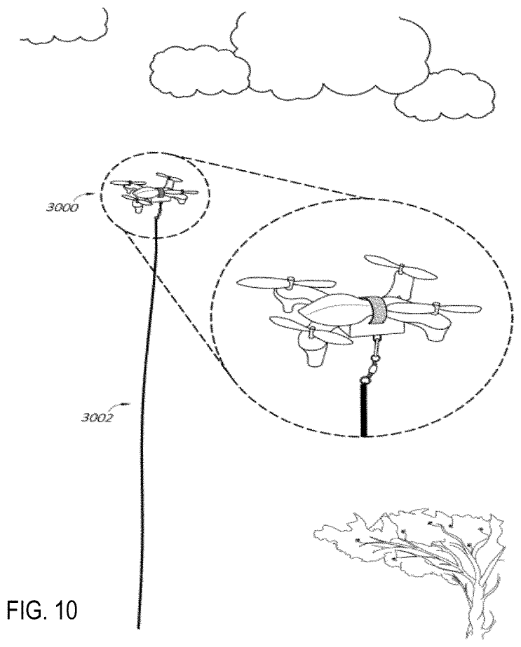

“Control mooring” is a term to describe a mooring system that provides an efficient and low-cost embodiment with many benefits. Embodiments of a “control mooring” system described herein control the maximum altitude and flight radius of the multicopter and can be used to hold the multicopter having a camera in a fixed position for taking photographs, taking selfies, or shooting video. The system also protects against fly-away from wind gusts and can be adjusted to avoid contact with obstacles, such as trees or nearby buildings. In addition, the system allows for flight in confined spaces such as indoors or outdoors in backyards, parks, and other small flying sites, where contact with structures or obstacles needs to be avoided. The “control mooring” system is also helpful whenever a flyaway could create hazards for the multicopter, people, pets, personal property, or the copter itself. For smaller multicopters, these occasions include flights outdoors on any day with more than a light breeze present. For all sizes of multicopters, the “control mooring” system is useful in locations near structures or obstacles that must be avoided, such as trees, crowds, buildings, highways, pools, or ponds. The “control mooring” system is also useful when inexperienced operators are still learning how a specific multicopter responds to manipulation of the levers on the transmitter. FIG. 10 illustrates a quadcopter 3000 attached to a “control mooring” 3002 according to one embodiment of this disclosure.

### Sky Mooring for Rotorcraft

In the “gyro position” format described herein, a small rotorcraft integrated with a kite is a simple illustration of the concept of a “sky mooring.” In the embodiments discussed below, the “sky mooring” concept makes unmanned rotorcraft safe, reliable, and practical for a wide range of new professional, recreational, and public-safety applications. These “sky mooring” embodiments share the common goals of overcoming the limitations imposed by limited flight duration and/or payload capacity while creating the same type of transparency that is inherent in tethered kites, balloons, or visible structures attached to the ground. As discussed in the background, battery-powered rotorcraft can have short flight times, which are limited by battery life. Kites, however, generate lift from the wind and are not limited to being powered by a finite source like batteries, and their payload capacities are higher than for comparably priced rotorcraft. But because they are powered by the wind, kites can be less steady. A rotorcraft coupled to a kite adapter can provide a “sky mooring” for the rotorcraft. And coupling a camera to the rotorcraft can provide utility to first responders, naturalists, journalists, fisherpersons, and photographers—individuals who could benefit from aerial photographic capability, without being concerned about the battery life of the rotorcraft.

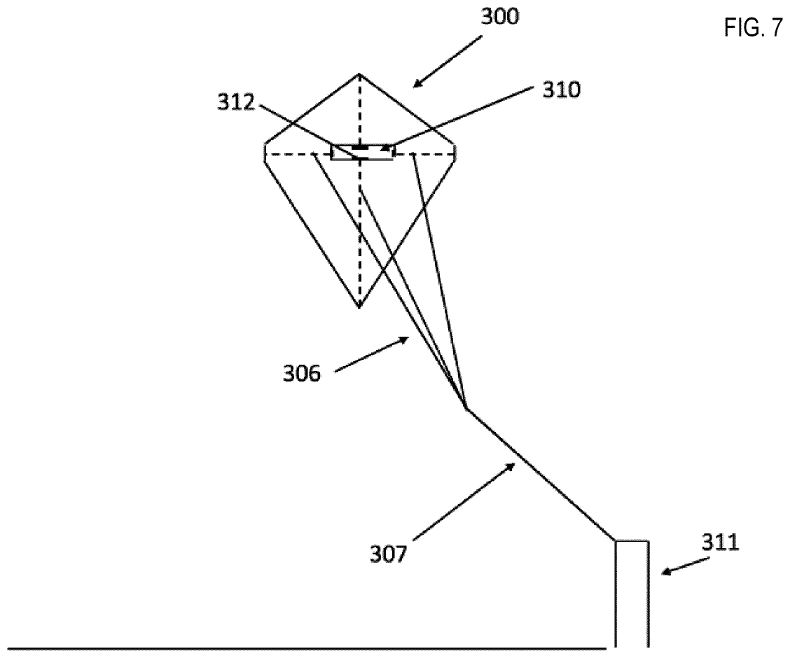

FIG. 7 illustrates another embodiment of a kite adapter 300. The kite adapter 300, includes an opening 310 for a rotorcraft such as a copter (not shown). The copter can be secured to the kite adapter 300 by way of brackets 312. The kite adapter 300 is similar to the one shown in FIG. 6 in that the copter is in a “gyro position” when secured to the kite adapter 300. The kite adapter 300 is secured to the ground via a post 311 via a bridle 306 and a cord 307. In this embodiment, the kite adapter 300 acts as a sky mooring for the copter.

A camera can be attached to the copter and thus the integrated unit provides an operator with aerial photographic capabilities without concern for short flight time. The camera can weigh more when attached to a kite in this configuration than a camera that could be lifted by the copter alone, thus allowing features such as a remotely controlled telephoto lens or a precision gimbal to be included. This is because once the copter is secured to the kite adapter 300, the copter does not need to expend energy to sustain flight and can have a greater payload capacity than the copter integrated with it. Moreover, though the kite adapter, as with traditional kites, may be unsteady at times in the wind, the copter rotors can be controlled by an operator to steady and point the integrated unit. In addition, as described in other embodiments, the copter can be secured to the kite adapter 300 such that it functions as a freely moving gimbal to point and control the camera or other devices (such as radar guns or infrared sensors), or the camera can be attached to the copter via a gimbal. In either configuration, the sky mooring provided by the kite adapter 300 and the copter when secured to the kite adapter 300, provides a steady aerial perspective from which photographs can be taken or other operations can be performed. This would allow for a multitude of applications. For example, observation of a wildfire that is partially extinguished to detect “hot spots” that require additional attention, photography of an outdoor wedding, suspension of strings of lights to be activated for an aerial light display that spells words or creates symbols for advertising or entertainment, or photography of other things being observed, including wildlife, water safety, rescue operations, or police surveillance. Infrared capabilities and a spotlight could allow use at night by a police department.

Optionally, when the camera or rotors are not in use or needed, the copter can be put in “sleep mode” remotely, in which the radio receiver remains active but stabilization features are disabled. This would further conserve the energy of the copter. The kite adapter 300 could also be made from solar material such that the kite adapter 300 could gather solar energy and charge the batteries of the copter. Other methods of recharging the batteries of the copter fall within the scope of this disclosure, including implementing chargers on the kite adapter 300 or including batteries attached to the adapter, such that when the copter is moored to the kite adapter 300, the batteries of the quadcopter are charged. A lightweight power cord could also be connected to the kite adapter such that power to recharge the batteries of the copter or activate lights or devices (such as radio repeaters) on the “sky mooring” could be supplied remotely.

In another embodiment, the copter can be released remotely from the brackets 312 and then fly free from the kite adapter 300. In this embodiment, the copter could be fitted with rods, servos or other structures that connect to the brackets 312 to secure the copter to the kite adapter 300. The rods, servos or other structure could be controlled remotely to retract or move in order to release from the brackets 312, which in turn would release the copter from the kite adapter 300. Alternatively, the brackets 312 could be designed to remotely clasp the copter when the copter is in the opening 310 and the operator wishes to secure the copter to the kite adapter 300. The operator could then release the copter by remotely unclasping the brackets 312 and using the rotors in the copter to cause it to “take off” from the adapter. The remote control of the brackets 312 or the rods, servos or other structure described above could be achieved through a button or other interface on the copter controller or controls on a separate, dedicated remote control unit.

To be more specific, here is a more detailed example of the remote launch system using the UDI™ U818A, a popular low-cost quadcopter. First, prop guards must be placed over the props on the U818A, such as by attachment using polyurethane glue (such as Original Gorilla™ Glue) of pieces of ping-pong netting over the tops and below the bottoms of the circular guards around each rotor. Alternatively, lines for the bridle or the tethering cord could be enclosed or coated to make them more rigid. These adaptations are designed to avoid line-tangle during operation. Next, a frame consisting of carbon fiber, bamboo, or fiberglass rods is constructed that is large enough to receive the U818A and that has a least 3 inches of clearance on all sides. This construction can use Kevlar™ thread and/or cable ties to wrap the joints, which are secured with Gorilla™ Glue. Depending on the lifting capacity of the kite or balloon to be used, the launching frame can be a simple rectangle or, for more stability, multiple rectangles that are mounted together with perpendicular rods about 1 or 2 inches apart. In the “launch-only” configuration, two grooved pieces are then constructed from halves of carbon fiber rods or joined pieces of bamboo in order to attach the landing skids of the U818A. These are mounted perpendicular to the frame and attached on top of the lower horizontal bars in the frame of the launching system so the U818A is held in the middle of the “box” with the front facing toward the rear of the kite, balloon, or structure used to suspend the frame. Loose zip ties are then attached with Gorilla™ Glue to hold the front portions of the skids of the U818A on the ends of the supporting grooved pieces with slack that allows them to slide off if the U818A is pushed forward an inch or less. A piece of carbon fiber rod or bamboo is mounted to keep the U818A from sliding backward beyond the point that is the center of gravity for the system when it is mounted (after attachment of one or more servos, as described below). Adjustments must be made so the U818A can lift, slide forward so the zip ties on its skids slide off the grooves below, and take off for normal flight. Then one (or, if lift is sufficient, two) standard model aircraft servos are mounted so the servo arms hold the rear vertical support(s) of the U818A against the backstop when it is positioned at the center of gravity of the launch system at the “locked in” position. The servo(s) should be adjusted so activation releases the U818A and pushes it forward enough for the zip ties to move over the edge of the groove. A small RC radio with its own light receiver battery is then connected to the servos, bound with any RC controller, and is configured so a switch on the controller will activate all servos and “launch” the U818A. Control of two servos by a single receiver channel can be achieved using a simply “y” connector. In a production model, control over launch might be achieved using the copter's remote controller with a dedicated switch and with a separate binding to the receiver on the launch assembly.

A more elaborate implementation of the launch system is described in the launch-and-retrieval discussion, below. Other variations of this system would be apparent to anyone skilled in the construction of model aircraft. If charging is desired, the light USB charger for the U818A would be taped in place with the line extended so it could connect with the female USB connector joined with a male USB connector supplying power from solar material on the kite, balloon, or structure. When the U818A is launched, the USB connection would be pulled apart by the movement of the copter, and the light charger would remain attached to the copter. Power could also be supplied from a supplemental battery attached to the source of support or from a power line if the assembly is mounted on a structure. The launch assembly could then be used for the remote controlled launch from an elevated location with support coming from a variety of sources, including not only kites and balloons but also a manned aircraft (including a manned helicopter) or a structure, such as a tower or the top of a building. If a safety line is to be used with the U818A, that could be added as discussed below.

Providing the ability to release the copter from the kite adapter 300 opens additional uses. The copter could be sent on a “photo assignment,” “surveillance assignment,” or “fishing trip.” The ability to preposition a multicopter with an elevated “sky mooring” is also useful when some event is expected to occur after a period of time that requires waiting, such as wildlife that may appear and merit closer photograph (e.g., dolphins surfacing near a shoreline); fish beginning to feed on the surface that indicates a promising fishing location; a wedding ceremony concluding and the camera needing to follow the bride and groom as they exit the ceremony; or some other important event beginning after an uncertain delay. In settings such as an outdoor wedding, releasing the copter from the kite adapter would be safer, less obtrusive, and more effective than sending a photographic copter from the ground as the event was progressing because the copter would already be aloft and, as such, would create less noise at ground level and would already be in position to easily avoid any objects or people that might obstruct flight by a copter launched from the ground. If a safety line is used, for example as discussed above in the “control mooring” embodiment with a mooring line, the copter could be confined to a specified distance from the “sky mooring” so there would be virtually no risk of accidentally flying into or over a seating area for guests or other areas where a flyaway or wind gusts could cause damage, injury, or anxiety. The safety line would tether the copter to the kite adapter, so even though the copter could be released from the kite adapter, its range of flight would be limited. Furthermore, the safety line could also be fitted with weights (such as one or more of the “tangle blocks” described above or small “shot” weights used in fishing positioned at intervals along the line) or with a heavier line “leader” as discussed above to help keep the line from obstructing the copter. The safety line could also have a remotely controlled winder (as discussed below) attached to the “sky mooring” to allow retrieval if the copter loses the ability to support itself for some reason and needs to be drawn back to the sky mooring. The copter could then be retrieved, repaired, and used again. One variation of this would use one or more copters and one or more sky moorings that would all be waterproofed so rain, high winds, or landings by the copter in water would not damage any of the components. This weather and water resistance would allow use during inclement weather (such as floods) for public service purposes and operation near or over the ocean or other bodies of water, or during rain, because water exposure would not damage any of the components.

In the event the safety line is cut or otherwise untethered to the copter, the copter can be configured to enter a safe or emergency landing mode (which is a mode known on certain rotorcraft) that automatically and safely lands the copter. In one embodiment, the safety line could be connected to a safety switch on the copter, with the safety switch activated before the copter is released from the kite adapter. After release or takeoff is detected, the safety switch would monitor line tension and cause the aircraft to go into “low battery mode” (and thus execute an immediate, soft landing) if tension is not reapplied promptly. The safety switch would be deactivated and the copter would land if the tension from the safety line is not detected for a pre-set period. Or alternatively, the copter could be programmed to fly automatically back to, and be retrieved by, the kite adapter or other sky moorings if the safety switch is deactivated. The safety switch innovation allows the copter to be flown with the safety line if tension is applied, at least periodically, to the safety switch. The safety switch could also be deactivated if the copter flies above a certain altitude or below a certain altitude. While the safety line and the safety switch has been described in connection with the sky mooring, it should be understood that a copter could employ a safety line and safety switch without a sky mooring or other kite adapter. For example, the safety line and switch can be used for children through optional parental control features to improve safety and guard against misuse of the copter. It could also be used for training purposes for inexperienced copter operators.

Next, in an even more versatile (and expensive) embodiment, the rods, servo, or other structures described above for the launch mechanism in the enclosure can also be used to allow the return of a copter to the “sky mooring” after it is dispatched. As one example, in the kite adapter 300, the docking structure can include two tubes (perpendicular to the opening) rather than the “grooves” as described in the example for the U818A above. The tubes facing the back of the kite would have “guide funnels.” The funnels would guide landing skids of the copter into the tubes. If the copter includes a “first person view” (FPV) camera, it could have a “sight” built into the retrieval structure that is positioned so the copter can be aligned properly using the FPV camera for the landing gear to slide into the funnels, and then the funnels would guide the landing gear into the tubes. On the copter, each landing skid might be shaped like half of a traditional wire coat hanger with the hook cut off. The copter would be mounted where the coat hanger's hook used to be and the sharp ends on the bottom would face forward on the copter (one on each side). These “skids” would then slide into the funnels and into the tubes. (Note that the funnels and tubes need grooves cut in the top to allow the support rod for each skid to slide in enough for the copter to reach the center of gravity for the launch-and-retrieval system.)

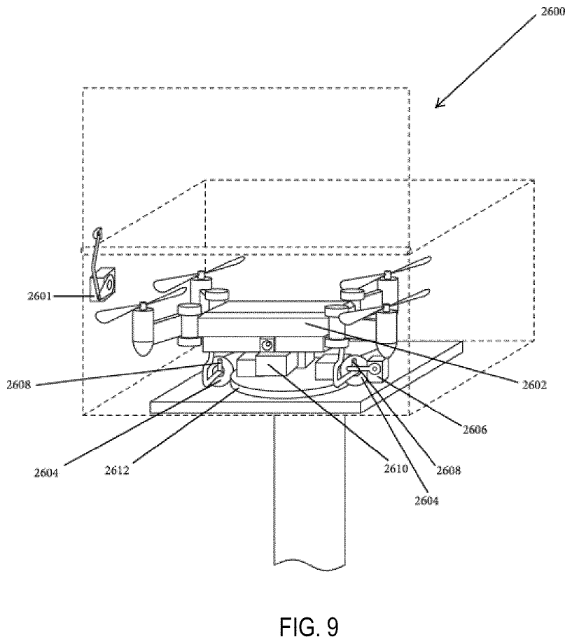

Once the copter is “flown” to the center of gravity in the launch system, a clasp or moving servo arm would “capture” the copter and lock in place, as described above. Other parts of the copter could “mate” with the retrieval station when it is captured for more stability and for other purposes. In a variation of this embodiment, a box-shaped enclosure with a door that could be closed and locked remotely could have the tubes and funnels described above facing forward; this would allow the copter to be retrieved from the front so the door could close behind it for protection of the copter and other systems from weather and tampering. In this embodiment, the copter would launch by flying backward out of the enclosure through the opening. Alternatively, the copter could be designed to be retrieved by flying in reverse, which would position it for relaunch in a forward mode, as illustrated in FIG. 9. The landing tubes described above could also be constructed so they could be remotely extended in front or in back of the “sky mooring,” allowing the copter to have open air above and below it while being launched or while being flown back to place the landing skid into the tubes for “capture” by a docking mechanism. In another embodiment, the mounting system could rotate, as described below, which would permit the copter to be inspected with a camera inside the enclosure or to move over alternate payload modules for attachment to the copter. In this embodiment, the enclosure might also have both a forward and rear door, allowing the copter to be retrieved or launched from two positions. A person with reasonable familiarity with multicopters would recognize that other variations are practical using this general structure.

In certain embodiments, “the automatic (or remotely controlled) opening and closure of a door or “lid” to protect the copter from wind, weather, vandalism, and theft until it is needed,” and use of a “lid” for a “sky mooring” can be combined with the line-and-pulley “control mooring” variation. A remotely-controlled “lid” (or other top-opening embodiments) would allow the use of “precision-landing” capabilities in multicopters such as the DJI® Phantom 4 Version 2 Pro. If this quadcopter model is taken off vertically and flown at least 30 feet straight up, its precision-landing system “memorizes” an image of the takeoff point, giving it the capability, when a return-to-home command is activated, to return to the GPS coordinates at the time of its launch and then to use its “downward vision system” to position it over the takeoff point and land with precision. When used on a “sky mooring” with a “lid” (or other top that can open), such a precision-landing system should descend to the original enclosure for automatic or semi-automatic retrieval. The accuracy of this kind of landing system may be further improved by an embodiment that includes a “target” the vision system can recognize reliably to guide the copter to its point of origin. For some locations, the addition of a flat platform around the bottom of the “sky mooring” may improve the functionality of automated landing systems on some multicopter models. In one embodiment, the operator would always maintain the capability to monitor the retrieval process and adjust the position of the rotorcraft during descent or abort the landing and start again, as appropriate. A person with reasonable familiarity with multicopters and outdoor utility structures, such as junction boxes, would recognize that other variations are practical using this general structure.

If a “lid” or other opening-top variant is used with weather-proof multicopters—such as the Phantom 4 series when equipped with a so-called “wet suit” or the Swellpro® Splash Drone series—additional embodiments can be tailored for reliable operation in different climates. As one example, weather proofing the internal operating components of the “sky mooring,” can allow the “lid” or top to be opened for launching or retrieval despite rain or snow. To further enhance all-weather capabilities in locations with significant temperature variations, a “sky mooring” enclosure can include systems for ventilation, heating, and/or cooling to protect the multicopter (including any heat-sensitive battery) and internal components from exceeding rated operating temperatures in summer, to thaw or dry the interior and components of the “sky mooring” after rain or snow enters it when the “lid” or roof is open, and to guard against falling below rated operating temperatures in winter. Drain holes are another optional feature in any opening-top variant to allow rain or melted snow to drain from the bottom of the enclosure. Heating coils on the top or sides of the “sky mooring” enclosure can also be added to melt snow or ice to ensure the top can be operated in winter. A person with reasonable familiarity with multicopters and outdoor utility structures, such as junction boxes, would recognize that other variations are practical using this general structure.

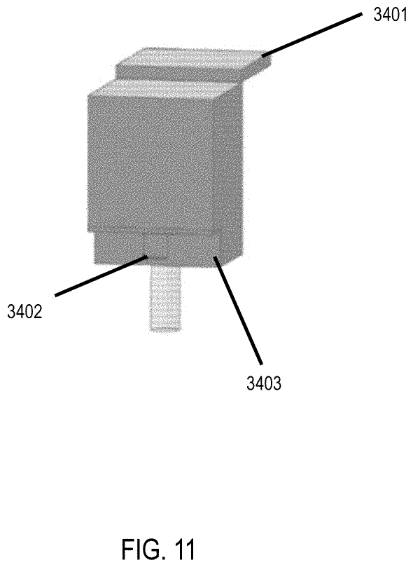

Numerous options exist to open the “lid” or top of a “sky mooring” structure and to tailor the shape of the enclosure to different mounting locations. One simple variant is to put a hinge or sliding rails on the “lid” and open it with one or more servos or arms, using gears, rods, and/or cables with pulleys to pivot or slide the “lid” out of the way. A variety of such systems are available for, among other things, remotely opening and closing chicken coops. FIG. 11 illustrates the exterior of an embodiment with a lid 3401 that can be opened remotely. A more complex variant that may be particularly useful if the “sky mooring” is mounted in an area close to another structure, such as a location on the side of a cell phone tower, is to have the top “roll” into the “sky mooring” itself, like an overhead garage door or a roll-top desk. The “lid” can also be divided into parts, and each part can be opened separately with its own servo(s) and gears or rods. Also, in a location with heavy snowfall, the “lid” may be pitched (like the roof of a typical birdhouse) to shed snow, and, in this or other configurations, the “lid” might be divided to open like a clam shell. A person with reasonable familiarity with multicopters and outdoor utility structures, such as junction boxes and chicken coops, would recognize that other variations are practically using this general structure.

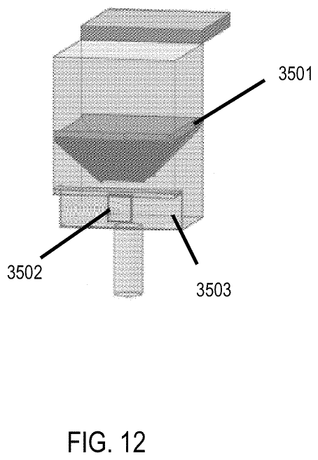

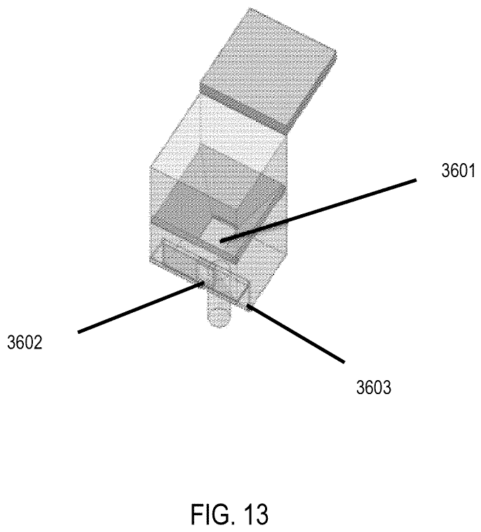

In an opening-top variant of a “sky mooring,” a “mezzanine level” of the enclosure can contain downward-slanted “shelves” that are positioned so the landing gear of a descending multicopter will slide down into the desired mooring position during landing (or when “bumped” remotely by an operator activating the propellers briefly after landing to move the copter up, down, forward, or backward for short distances). FIG. 12 illustrates a “mezzanine” level with slanted shelves 3501. FIG. 13 illustrates an opening 3601 in this “mezzanine” level that can be sized to fit around the land gear of a specific model of multicopter. For example, standard “U” shaped landing skids, like those on the DJI® Phantom series, or retractable landing “feet” like those on the DJI® Matrice series or the Yuneec® Typhoon series, would slide down to a middle position if slanted “shelves” 3501 are positioned on each side and in front and back of the desired moored location 3601 for the skids as the multicopter lands (or after it is “bumped” as described above). If the multicopter has retractable landing gear, the enclosure can be configured so that retracting the gear after landing in the enclosure would lower the multicopter slowly and place the camera into a dome on the enclosure, as described above; this position would allow the camera to use its integral gimbal to pivot and tilt to maximize the field of view while docked in the “sky mooring” enclosure. In this embodiment, the multicopter may not require a locking mechanism to hold it in position for some applications because gravity would be sufficient to do so. Also, the “stock skids” or “feet” of the multicopter would not have to be changed in this variant. The slanted shelves would position the multicopter with enough precision for use of an induction charging connection (as described below) or for use of a rotating turntable to install payload modules, also as described below. If a payload-module changer is used, a locking mechanism may then be helpful to hold the copter in position when a module is removed or installed. A person with reasonable familiarity with multicopters and outdoor utility structures, such as junction boxes, would recognize that other variations are practical using this general structure, such as using shapes other than shelves to guide the landing gear into precise position for use of the camera, for connection with a charging system, or for operation of a turntable to change modules.

For example, recharging of the copter battery could be activated in one of many ways once the copter is secured, including use of an induction charging system of the type used by electric toothbrushes to charge batteries without a physical connection or a moving plunger that makes an actual connection to a USB port. This system could have independent utility even if not mounted on a balloon or kite that could be retrieved; if mounted on the light poles of a sports stadium, for example, the “launch and retrieval systems” might be weather-proofed and remain in position permanently, but copters with appropriate adaptations could be “flown up” and placed in position before a scheduled event and then flow down and stored safely after the event ended.

The sky mooring concept for copters has many public safety applications, particularly when the concept of special-purpose copters is also applied. For example, kite adapters or balloons with copters in launch systems could be put up near anticipated high-risk events to observe people and dispatch one or more copters to take photographs and intervene to prevent any illegal activity or risks. One launch system enclosure could be used with a number of copters that share the same landing skids and body design, and the enclosure could be designed for easy attachment between different support systems, including kite adapters, balloons, use on security towers, or on roofs of buildings. A single launch system could be used with a number of different special-purpose copters that are designed or equipped for specific situations, and a police department could simply select the appropriate special-purpose copter for the planned use. The cost of copters is relatively low and is expected to drop lower, so maintaining multiple special-purpose copters for use with one sky mooring system (or a series of such systems, as discussed below), is both practical and cost effective. For example, police (including Secret Service officers) who are dealing with crowd risks at events such as a marathon, protest march, or Presidential Inauguration could use “crowd management” copters equipped with public address systems (like those in some police cars) so a copter could fly down over an apparent disruption in a crowd to give loud, localized vocal warnings to persons in that specific area if a dispute arises or if there is concern about a possible unsafe package or weapon. All this would be recorded on video for use as evidence later and would be visible to the operator using an FPV camera. The copter could also have an “intercom” feature that allows the operator to hear responses from those who are near it. If the issue is resolved peacefully, the copter could then return to its “sky mooring” and continue to provide a video feed while its batteries are recharged.

Special-purpose copters would become even more useful if “sky moorings” are equipped with the capability to support a number of variations that all share the same landing devices and physical dimensions. A “payload module” that fits into a position on the copter as part of the copter's fuselage could carry specialized equipment or payloads. As described below, these “payload modules” could either be changed manually by an operator before a planned use or a sky mooring enclosure could be equipped with the “changer” system described below to “swap” payload modules quickly and remotely.

As noted, FIG. 9 illustrates an embodiment of a “sky mooring.” For example, FIG. 9 illustrates an enclosure 2600, in which a copter 2602 is positioned. The copter 2602 includes a set of landing skids that can be positioned in funnels 2604. The enclosure 2600 also includes a servo 2601 whereby opening and closing of the enclosure can be achieved remotely. The system described in FIG. 9 also includes another servo mechanism 2606 for locking the copter in place when the skids are positioned in the funnels 2604. In this embodiment, the servo 2606 acts as an arm at a typical railroad crossing. The servo 2606 rotates to a 12:00 position to release the copter, and as shown in FIG. 9 is in the 9:00 position to lock the copter into place. The skids of the copter 2602 include protrusions 2608, with the protrusion on the right skid abutting the servo 2606 when the servo 2606 is in the locked position (i.e., the 9:00 position).

The protrusions 2608 on the skids fit against the funnels 2604 This is what holds the copter in the tube after it “lands” in the mooring. The protrusion 2608 on the left skid is useful, even without a corresponding servo, for balance of the copter in flight and because it provides a “stop” so the skid on the left goes the same distance into the tube as the one on the right. This “stop” position, in turn, helps to hold the copter accurately in the same position at all times after docking so a plunger (which is not shown) can remove a module. More specifically, the copter includes a module 2610 and beneath this module 2610 and the copter 2602 is a turntable 2612 supporting a plurality of modules that can then rotate (like a CD changer) to move the “old” module 2610 away and position a different module under the front. The same plunger below the turntable can then lift that new module up to fit into the “module receptacle space” so the copter is ready for a different “mission” with different supplies or equipment.

The sky mooring concept, combined with the launch and retrieval system and changeable payload modules, mitigates payload-capacity and flight-duration limitations because copters can be equipped for specific purposes and the appropriate configuration can be pre-positioned in sky moorings to meet the needs of specific events or risk areas. For example, one “fleet” of public safety copters (operated by a police department or other governmental agency) could also carry special devices to “intervene” at trouble spots. If properly licensed for police use, these devices might allow possible use of a crowd-dispersal device, such as pepper spray, mace, tear gas, or even a Taser. The ability to control these devices remotely would reduce risk to police because an irrational person who seems to be dangerous could be confronted remotely.

Such a fleet of special-purpose copters could then be reconfigured or replaced by other copters for use in the same sky mooring systems to deal with other anticipated public-service needs. For example, in preparation for a gathering at which medical issues seem more likely to create risks than disruptive behavior (such as a college reunion or charitable fund raising rally), a police department or other agency could replace some or all of the “crowd-management copters” described above with “medic copters” (or copters with “medic payload modules”) in its sky moorings system(s). If kites or balloons were used for support, these replacements could be made on the ground; if the sky moorings are mounted on structures that are difficult to reach (such as light towers around a sports stadium or cell towers), changing the special-purpose copters could be easily achieved using the “launch and retrieval systems.” The “medic copters” could be equipped with the public address and “intercom” systems (as described above) for communication with bystanders who might gather around someone who passes out or appears to be having a heart attack. The special “medic copters” could carry medical devices and emergency medications, such as “EpiPen®” for allergic reactions, naloxone (also called Narcan™) to treat opioid overdose, and a light-weight Automatic External Defibrillator (AED) for a victim of cardiac arrest. Operated by someone with medical training, the copter could reach the location of a person in distress more quickly than paramedics (especially if, for example, multiple “sky mooring” locations existed around an event, such as on the lights poles around a stadium, each with a “medic copter”). Using the camera and intercom, the operator could determine if a doctor or other person with medical training was present and, if the copter carried anything helpful, could explain how to access it. If no one with medical training was present, the operator could provide instructions to “talk through” (and observe on the FPV camera) use by a bystander of medical equipment on the copter, such as an AED, naloxone injector, or EpiPen. With the ability to retrieve the copters and replace them easily with others, the type and mix of special-purpose copters in the “sky moorings” might be changed (manually or remotely, as described above), either when supported by kites or balloons or permanent structures, to suit different needs. If a stadium had to be used during an emergency for those who were not able to stay in their homes (such as during a hurricane), and if multiple sky moorings were mounted in the towers that support the lighting systems, the “mix” of special purpose copters might be changed to include some with “crowd management” features and others that are “medical copters,” for example. As noted above for more sophisticated embodiments, the copter might accept interchangeable “payload modules” that contain equipment for specific uses, and a “module-changer” (using existing technology similar to that in CD changers) in the sky mooring (as illustrated in FIG. 9) could allow the operator to install any available module by remote control.

Special purpose copters in “sky moorings” could also be used during disaster recovery (e.g., an earthquake), regulatory monitoring, traffic incident management, or search and rescue operations. In earthquake-prone areas, for example, copters could be stationed in sky moorings (either supported by kites, balloons or mounted on earthquake-resistant structures) and dispatched quickly after a quake if there is a report of possible sounds from trapped survivors. The copters could carry the intercom system described above to have two-way communications between the operations center and anyone on the ground to describe conditions. Almost any standard multicopter would automatically send back its precise GPS coordinates and photos from the location, and, in the earthquake example, the copter could be equipped with an attached listening device to amplify sounds and direct volunteers until heavy equipment could arrive. In an avalanche situation on a ski slope, special purpose copters from sky moorings could search for those who were trapped under snow using infrared devices and could carry limited rescue supplies. Regulatory agencies could use sky moorings with specialized copters for compliance monitoring. For example, remotely-viewable video cameras in conjunction with specialized copters in a network of sky moorings could allow an environmental regulator in a central location to observe smokestacks at multiple high-risk industrial sites and remotely “dispatch” one of those copters for on-site air testing whenever an anomalous emission is suspected (or for routine air sampling at various altitudes). Such a system of “sky moorings” could also be installed along a highway (or series of highways) and linked to a central operations center for incident management by state police or other emergency services. As described above, cameras in the multicopters could operate through windows in the “sky mooring” enclosures to serve as traffic or surveillance cameras whenever a copter is moored. FIGS. 11, 12, and 13 illustrate one example of placement of a window 3402, 3502, and 3602 in a “sky mooring” enclosure” In order to place the multicopter camera close to such a window for use of its camera, the bottom of the “sky mooring” can have an indent 3403, 3503, and 3603 so the glass is close to the front of the camera in the moored position. A lens could also be placed between the camera position and the window to improve the field of view while moored. Alternatively, the enclosure can be designed so the camera is positioned in a transparent “dome” on the bottom of the enclosure; such domes are commonly used to weatherproof outdoor security cameras with a pan-and-tilt capability. Systems for central monitoring and control of a group of multicopters are generally available, such as one marketed by DJI® for use with its Matrice 600 series of commercial hexacopters. Adding channels to these systems for remote control over the “lid” and other components of the “sky mooring” installation should be relatively simple to implement. Increased range and reliability of control can be obtained by using enhanced or directional antenna systems on the “sky mooring” enclosures and, for public service applications, by seeking a waiver from the FCC or other relevant regulatory authorities allowing increased power for transmitters associated with the enclosure and in the multicopter. Use of low-latency signal repeaters is also within the scope of this embodiment. In the case of a lost animal or lost person, especially in rough terrain, specially equipped copters from sky moorings could operate for long periods of time from a supporting kite or balloon and still be “dispatched” for a closer look if something is observed on the camera (or reported by a ground observer) suggesting that the subject of the search might be in a particular location. An embodiment that includes a signal repeater on the sky mooring system would allow two-way communications even in mountains, both to control the copter and to allow cellular communications with a phone the copter might carry to the lost person. A person with reasonable familiarity with multicopters, industrial remote-control systems, and security-camera or traffic-camera systems would recognize that other variations are practically using this general structure.

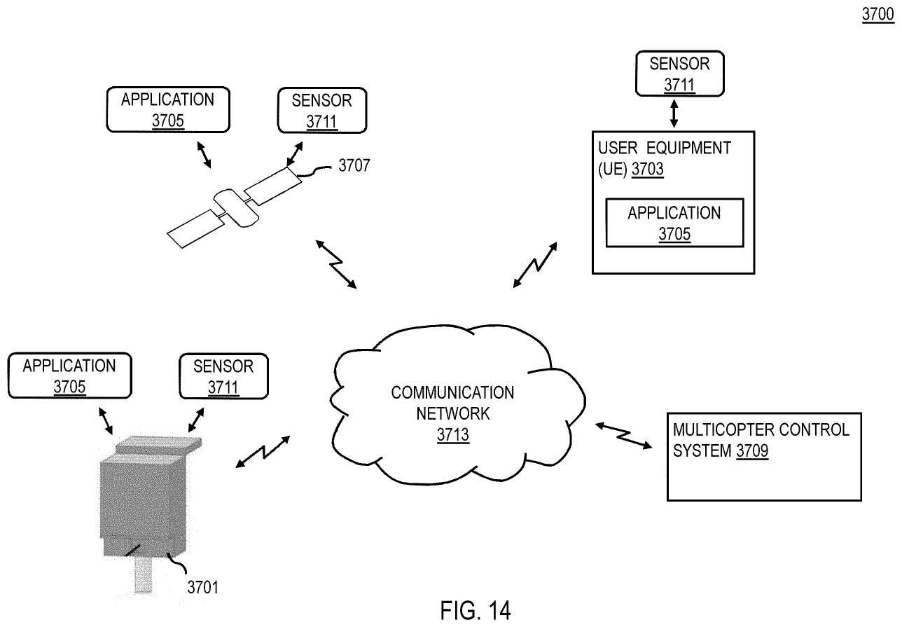

As shown in FIG. 14, system 3700 comprises an elevated structure 3701 and user equipment (UE) 3703 that may be associated with application 3705 and sensors 3711. In one embodiment, the elevated structure 3701 and UE 3703 has connectivity to a multicopter control system 3709 via a communication network 3713, e.g., a wireless communication network.

In one embodiment, elevated structure 3701 is a weatherproof enclosure comprising: a remotely controlled door; one or more downward-slanted shelves in a mezzanine level for sliding a landing gear of a descending multicopter into a correct position; at least one window on the sidewall; an indent in a bottom surface of the elevated structure for placing a camera of the descending multicopter in front of the at least one window; and a turntable supporting a plurality of modules. In one embodiment, the window comprises transparent materials and is dome-shaped. In another embodiment, the mezzanine level of the elevated structure comprises an opening to fit around the landing gear of the descending multicopter. In a further embodiment, sidewalls and/or surfaces of the elevated structure comprises solar material to consume solar energy for recharging batteries of the multicopter in a landed position.

In one embodiment, the elevated structure 3701 comprises guide lasers to project beams with specific colors for detection by the sensor of an airborne multicopter 3707. In another embodiment, the elevated structure 3701 comprises a plurality of patterns on the top surface and/or bottom surface of the elevated structure 3701, or on a platform that extends around the base of the enclosure, for detection by the sensor of the airborne multicopter 3707. In a further embodiment, the elevated structure 3701 comprises thermocouples for heating and cooling the exterior and interior of the elevated structure 3701 to keep the multicopter 3707 and other components operating.

In one embodiment, the UE 3703 may include, but is not restricted to, any type of a mobile terminal, wireless terminal, fixed terminal, or portable terminal. Examples of the UE 3703, may include, but are not restricted to, a mobile handset, a wireless communication device, a station, a unit, a device, a multimedia computer, a multimedia tablet, an Internet node, a communicator, a desktop computer, a laptop computer, a notebook computer, a netbook computer, a tablet computer, a Personal Communication System (PCS) device, a personal navigation device, a Personal Digital Assistant (PDA), a digital camera/camcorder, an infotainment system, a dashboard computer, a television device, or any combination thereof, including the accessories and peripherals of these devices, or any combination thereof. In one embodiment, the UE 3703 may support any type of interface for retrieving, dispatching, and enclosing a multicopter in an elevated structure. In addition, the UE 3703 may facilitate various input means for receiving and generating information, including, but not restricted to, a touch screen capability, a keyboard and keypad data entry, a voice-based input mechanism, and the like. Any known and future implementations of the UE 3703 may also be applicable.

In one embodiment, the application 3705 may include various applications such as, but not restricted to, location-based service application, a navigation application, content provisioning application, camera/imaging application, and the like. In one embodiment, the application 3705 is installed within the elevated structure 3701, UE 3703, and multicopter 3707. In one example embodiment, a location-based service application enables a multicopter control system 3709 to determine, for example, position, geographic co-ordinates, heading, speed, context, or any combination thereof, of multicopter 3707. In another embodiment, the camera/imaging application installed in the multicopter 3707 enables the multicopter control system 3709 to determine one or more targets for precision-landing in the elevated structure 3701. In a further embodiment, the application 3705 enables the multicopter control system 3709 to process communication information and/or contextual information and/or sensor information to determine at least one instruction to an airborne multicopter 3707 for a precision-landing in the elevated structure 3701.

The system 3700 also includes one or more sensors 3711, which can be implemented, embedded or connected to the elevated structure 3701, UE 3703, and multicopter 3707. The sensors 3711 may be any type of sensor. In certain embodiments, the sensors 3711 may include, for example, but not restricted to, a global positioning sensor for gathering location data, such as a Global Navigation Satellite System (GNSS) sensor, Light Detection And Ranging (LIDAR) for gathering distance data, a network detection sensor for detecting wireless signals or receivers for different short-range communications (e.g., Bluetooth, Wi-Fi, Li-Fi, Near Field Communication (NFC) etc.), temperature sensors, a camera/imaging sensor for gathering image data, e.g., the camera sensors may detect targets and the like. In another embodiment, the sensors 3711 may include light sensors, oriental sensors augmented with a height sensor and acceleration sensor, e.g., an accelerometer can measure acceleration and can be used to determine orientation of the multicopter 3707, tilt sensors, e.g. gyroscopes, to detect the degree of incline or decline of the multicopter 3707 during landing, moisture sensors, pressure sensors, etc. In a further embodiment, the sensors 3711 comprises weather sensors for determining weather conditions, wind velocity, wind directions, or a combination.

In one embodiment, a multicopter control system 3709 may be a platform with multiple interconnected components. The multicopter control system 3709 may include one or more servers, intelligent networking devices, computing devices, components, and corresponding software to configure an elevated structure 3701 and multicopter 3707 for safe retrieval and dispatch. In one example embodiment, the multicopter control system may receive a command from a user via his/her UE 3703 to return the multicopter 3707 to the elevated structure 3701, whereupon the multicopter control system 3709 instructs the airborne multicopter 3707 in real-time to return to the elevated structure 3701. Subsequently, the elevated structure 3701 opens its door, and the multicopter 3707 detects one or more targets, e.g., patterns on the bottom surface of the elevated structure 3701, beams with specific colors projected by guide lasers, etc., for precision-landing. At the same time, multicopter control system 3709 determines in real-time geographic co-ordinates of the airborne multicopter 3707, wind velocity, and wind directions via sensors 3711 to generate and transmit instructions to the airborne multicopter 3707 for a precision-landing, e.g., correct position information for automatic landing. In one example embodiment, precision-landing comprises safely sliding a landing gear of a descending multicopter through the downward-slanted shelves or other guiding structures tailored to the landing gear of a specific multicopter into an indent for positioning a camera of the descending multicopter in front of the window to observe the environment outside the elevated structure. In another example embodiment, precision-landing comprises safely sliding a landing gear of a descending multicopter through the downward-slanted shelves or other guiding structures to activate an induction charging system to charge the battery and supply power to the camera and transmitter of a docked multicopter. In a further example embodiment, precision-landing comprises safely sliding a landing gear of a descending multicopter through the downward-slanted shelves or other guiding structures to interact with a rotating turntable for replacing the older module of the docked multicopter with the different module. In one embodiment, a rotating changer and/or mechanical arm in the elevated structure 3701 positioned below the docked multicopter 3707 can be remotely instructed to remove modules from the multicopter 3707 and place it in the turntable, and then rotate a new module into position and attach it to the multicopter 3707. The new modules comprise medical devices chosen from the group including an automatic external defibrilator, epi pen, and an insulin injector.

In one embodiment, the multicopter control system 3709 may activate a forced air cooling system of the elevated structure based, at least in part, on a determination that temperature in the elevated structure is above a prescribed threshold, thereby preventing a docked multicopter from overheating. In another embodiment, the multicopter control system 3709 may activate a forced air heating system of the elevated structure based, at least in part, on a determination that temperature in the elevated structure is below a prescribed threshold, thereby maintaining operating temperature. In a further embodiment, the multicopter control system 3709 may activate a de-icing system of the elevated structure during cold and freezing weather condition for securely opening and closing the doors. In another embodiment, the multicopter control system 3709 rotates and tilts the elevated structure for expanding a field-of-view of the camera of a docked multicopter, wherein the elevated structure is mounted to another structure.

In addition to delivering a cell phone that would work with the repeater on the sky mooring system to communicate with a lost person when they are located (so they could report on their status and needs), such search-and-rescue copters might carry water and first-aid supplies. As noted above, copters coupled to “sky moorings” could also be used in fighting forest fires (or other types of fires) by watching for “hot spots.” Tethering of multicopter in a forest fire environment (by integration with a kite, balloon, or control mooring system) would avoid the risk that the copter might interfere with aerial fire-fighting operations. The effectiveness of those units could be increased by including specialized equipment, such as infrared temperature-sensing gear, to check on conditions on the ground, send photographs, and determine the most effective deployment plan for firefighters. For clarity, while some embodiments on the sky mooring concept have been described only in connection with a kite adapter, it should be understood that balloons, balloons attached to kites, arrays of kites, or other structures attached to the ground could constitute a “sky mooring.” In addition to light poles (such as those at sports stadiums) that were mentioned above, buildings, bridges, highway signs, cell towers, and other structures could function to support a sky mooring for the copter and could be equipped with a variant or embodiment of the launch-and-retrieval and provisioning systems described above. Sky moorings might also be positioned by attaching them to manned aircraft (including helicopters) or other vehicles, such as police S.W.A.T. team vans, fire trucks, cranes, or boats. In some adaptations, a telescoping tower could be attached to a vehicle (or positioned temporarily with a tripod or other base) to elevate the sky mooring above trees, crowds, or other obstructions, optionally in conjunction with an observation “booth” in which one or more police or security officers could also observe events directly. Further, to be clear, the use of a safety line or wire tether to provide power from the “sky mooring” to a copter that is dispatched is optional for all of these examples. Some of the embodiments discussed above to prevent line tangling and described below in connection with retrieval mechanisms should expand the utility and practicality of including a safety line.

If the “precision landing” feature in the multicopter selected by the user is not accurate enough for automated return to a sky mooring, the retrieval system could have an automated-docking-and-resetting feature. This system would extend functionality beyond the “return to home” feature, which is commonly included in copters in the same class as the Phantom 4 Pro, so copters could reliably be returned without manual landing procedures and could be reset remotely for later use without the need for access to the copters between “assignments.”

In addition to the normal switch on the remote controller for a “return to home” application, which normally causes the copter to return to the vicinity of launch (using the onboard GPS) and execute a soft landing automatically, a “return to sky mooring” switch (or position on a multi-position switch) could be added to the controller for the copter or, optionally, on a separate controller for the sky mooring. Activating the “return to sky mooring” sequence would cause the copter to return to the original position and altitude when it was launched from the sky mooring and would then execute additional “search and acquire” actions to locate a “landing beam” that would lead it to a position at which it could “land” in the sky mooring and then be locked into position. As noted above and discussed further below, this capability might be further enhanced by creating a “target” in or around the bottom of the “sky mooring” that a “downward vision system” on board a multicopter could use to achieve an automatic or semi-automatic landing. The operator would retain the capability to exercise manual control over the copter, as well, to position the copter using the FPV camera, if needed. This feature could also be set to activate itself if the remote signal is lost or if battery power reaches a certain level.

More specifically, the programming of the flight control system in the Phantom 4 Pro (or a comparable sophisticated GPS-controlled multicopter) for “return to home” would be supplemented to achieve the “return to sky mooring” mode by requiring return to be at the same altitude as the launch position from the sky mooring and with the skids positioned (using the on-board compass) to face the receiving funnels. Depending on the precision capabilities of the “return to home” feature (and with an adjustment for wind that could be set by the operator remotely, compensated for by manual flight control, or, as described below, could be set automatically) the designated position would be adjusted so it would be a safe distance in front of and slightly above the sky mooring. The wind adjustment could be set automatically based on a signal from the sky mooring that is keyed to a wind speed indicator mounted on it.

The sky mooring could be equipped with at least two “guide lasers” that project beams with specific colors that could be easily detected by cameras with special filters on the copter. One of these lasers would be set to project a fan-shaped pattern (possibly by moving the beam back and forth rapidly) in a horizontal plane and the other would be set to project a “landing beam.” In a variant of this embodiment, one or more low-power lasers could be positioned or arrayed to create a “target” for the vision system for a specific multicopter to guide it to a more-precise landing position in the “sky mooring” enclosure.

In another variant, one, two, or more small (and light) cameras on the copter would be fitted with appropriate filters, mounted to face forward or downward, and adjusted to detect the fan-shaped laser that designates the proper position for the copter to land or move into the funnels or other hardware on the sky mooring that were designed to receive the copter's skids, including the downward-slanting shelves described above. This “altitude-hold camera system” or “location positioning system” would be connected with the altitude-hold software (already included in all copters of this class) to maintain the proper altitude for retrieval with more precision than an altimeter or GPS allows. If three cameras are used (or if one camera is programmed to detect three positions), the camera could provide feedback to hold altitude if the beam is detected in the specified “correct altitude” position, to lower the copter slightly by reducing thrust if the position is “high,” and to raise the copter if the position is “low.”

One, two or more separate small (and light) cameras would be positioned to detect the “landing beam” laser after the vertical position is set (and stabilized using the altitude-hold laser). A search to find the landing beam would be conducted by moving the copter left and right until the landing beam is found. Alternatively, one sophisticated camera could be programmed to perform both the function of locating the altitude-hold laser and the landing-beam laser. In an open-top “sky mooring” embodiment, this system could be programmed to land gently on the “target” in the “sky mooring” enclosure.

For a system that retrieves the multicopter horizontally, as described above, the landing-beam laser would be adjusted so the copter should be positioned to fly forward at the same altitude and cause the skids to enter the funnels and then the tubes or other structures to receive the skids (as described above). One of several detection systems (including a simple switch activated when the skid of the copter presses against it at a specified location in a landing tube) could be used to determine when this has been achieved and, if not, to send the copter back to try again when the wind, movement of the sky mooring, or other factors cause the effort to fail. When properly adjusted (and in conditions with low wind or constant wind or with manual compensation by the operator), the automated-docking system should achieve retrieval and some variation of the locking system described above would then hold the copter in place and initiate the “post-mooring sequence” described below. In an embodiment in which the sky mooring is on a moving object, such as a kite, balloon, or hovering manned helicopter, a GPS on the sky mooring system might report its location to the receiver in the copter, which could then be programmed during the “return to sky mooring” sequence to proceed to the current location of the sky mooring if it has been moved from the original launch position. A person with ordinary skill in programming flight control systems for RC copters would be able to understand and implement this feature.

In a sophisticated system, the sky mooring might be programmed to take any other “post-mooring” actions to “reset” the copter, so it would be protected and prepared for use again. In addition to charging batteries as described above, these actions might include the automatic (or remotely controlled) opening and closure of a door or “lid” to protect the copter from wind, weather, vandalism, and theft until it is needed again (as illustrated in FIG. 9). Systems in the enclosure could also support remote or automatic initiation of a data connection (such as a remotely controlled plunger or motorized arm to plug a USB or other connection from the sky mooring enclosure into a matching port on the fuselage of the copter) that could allow remote rebooting and/or recalibration of the computer system(s) on the copter or downloading and transmission to the operator via the Internet or other means of photographs from an SD card in the camera (to allow higher resolution than the video sent back in flight). The enclosure might also have its own “Wi-Fi” system if the multicopter has built-in “Wi-Fi” capability. Other systems in an embodiment of this enclosure might permit remote activation of an “inspection camera” within the enclosure with the copter on a rotating base to allow remote inspection of the copter for damage (optionally with the copter on a rotating base to allow all sides to be examined), changing the payload modules as described above, remote replacement of damaged rotor blades, etc. It should be understood that a range of quasi-robotic maintenance or configuration operations become practical under remote control when a copter is returned to a closed sky mooring enclosure, and all of those embodiments are within the scope of this disclosure. For high-risk uses, such as along an international border or around a prison, the enclosure could be armored to reduce risk from rifle shots. The enclosure could have one or more external surveillance cameras, and, as noted above, the multicopter's own camera might be available remotely through a window in the closed door. The enclosure could be remotely rotated or tilted to angle the camera on the copter and so the flight path of the multicopter would be shorter when an event requires a dispatch for closer investigation.

While embodiments have been illustrated and described herein, it is appreciated that various substitutions and changes in the described embodiments may be made by those skilled in the art without departing from the spirit of this disclosure. The embodiments described herein are for illustration and not intended to limit the scope of this disclosure.

What is claimed is:

1. A multicopter control system comprising:
an elevated structure configured to retrieve, dispatch, and enclose at least one multicopter, said structure comprising:
one or more positioning structures in a mezzanine level for guiding a landing gear of a descending multicopter into a correct position;
at least one window on a sidewall; and
an indent in a bottom surface for placing a camera of the descending multicopter in front of the at least one window to observe the environment outside the elevated structure.

2. The multicopter control system of claim 1, wherein the one or more positioning structure comprises downward slanted shelves, and wherein the one or more positioning structure places the landing gear of the descending multicopter with required precision to activate an induction charging system, replace an older module from the at least one multicopter with a different module, or a combination thereof.

3. The multicopter control system of claim 2, further comprising:
replacing the older module from the at least one multicopter with the different module by a rotating turntable supporting a plurality of modules.

4. The multicopter control system of claim 1, further comprising:
transmitting a command to an airborne multicopter to return to the elevated structure;
determining geographic co-ordinates of the airborne multicopter;
determining at least one target in the elevated structure, outside the elevated structure, or a combination thereof by a sensor of the airborne multicopter, wherein the sensor is a camera sensor, an imaging sensor, or a combination thereof; and
transmitting instructions to the airborne multicopter for a precision-landing in the elevated structure based, at least in part, on the determination.

5. The multicopter control system of claim 4, wherein the at least one target comprises a plurality of patterns on one or more surfaces in the elevated structure, one or more surfaces outside the elevated structure, or a combination thereof.

6. The multicopter control system of claim 4, further comprising:
creating the at least one target by a plurality of guide lasers of the elevated structure, wherein the plurality of guide lasers project beams with specific colors for detection by the sensor of the airborne multicopter.

7. The multicopter control system of claim 4, further comprising:
determining weather conditions, wind velocity, or a combination thereof by one or more sensors associated with the elevated structure, the at least one multicopter, or a combination thereof; and
transmitting instructions to the airborne multicopter for a precision-landing in the elevated structure based, at least in part, on the determination.

8. The multicopter control system of claim 7, further comprising:
activating a forced air cooling system of the elevated structure based, at least in part, on a determination that a temperature in the elevated structure is above a prescribed threshold.

9. The multicopter control system of claim 7, further comprising:
activating a forced air heating system of the elevated structure based, at least in part, on a determination that a temperature in the elevated structure is below a prescribed threshold.

10. The multicopter control system of claim 7, further comprising:
activating a de-icing system of the elevated structure during cold and freezing weather condition.

11. The multicopter launch system of claim 1, further comprising:
rotating and tilting the elevated structure for expanding a field-of-view of the camera of a docked multicopter, wherein the elevated structure is mounted to another structure.

12. The multicopter launch system of claim 11, further comprising:
a remotely controlled lid for retrieving or dispatching the at least one multicopter, wherein the lid may be configured as a roll-top desk.

13. An elevated structure for enclosing a multicopter comprising:
at least one remotely controlled door;
one or more positioning structures in a mezzanine level for sliding a landing gear of a descending multicopter into a correct position;
at least one window on a sidewall; and
an indent in a bottom surface for placing a camera of the descending multicopter in front of the at least one window.

14. The elevated structure of claim 13, wherein the one or more positioning structure comprises downward slanted shelves, and wherein the downward slanted shelves comprises an opening to fit around the landing gear of the descending multicopter.

15. The elevated structure of claim 13, wherein the at least one window comprises transparent materials, and wherein the at least one window is dome-shaped.

16. The elevated structure of claim 13, further comprising:
a turntable supporting a plurality of modules,
wherein the one or more positioning structures positions the descending multicopter to a required precision to use the turntable to install different module.

17. The elevated structure of claim 13, wherein the at least one remotely controlled door is divided into one or more parts, and wherein each of the one or more parts can be opened separately by their respective servos, gears, rods, or a combination thereof.

18. The elevated structure of claim 13, wherein one or more sidewalls, one or more surfaces, or a combination thereof of the elevated structure comprises solar energy absorbing materials.

19. The elevated structure of claim 13, further comprising:
guide lasers to project beams with specific colors; and
a plurality of patterns on one or more surfaces in the elevated structure, one or more surfaces outside the elevated structure, or a combination thereof.

20. The elevated structure of claim 13, further comprising:
a plurality of sensors; and
a forced air cooling system, a forced air heating system, and a de-icing system.
